(19) United States
(12) Patent Application Publication
(10) Pub. No.: US 2025/0388266 A1
(43) Pub. Date: Dec. 25, 2025

(54) FRONT SIDE VEHICLE BODY

(71) Applicants: Hyundai Motor Company, Seoul (KR); Kia Corporation, Seoul (KR)

(72) Inventors: Jong Gwan Yun, Hwaseong-Si (KR); Yong Dok An, Hwaseong-Si (KR); Do Hoi Kim, Hwaseong-Si (KR); Mun Soo Cha, Hwaseong-Si (KR)

(73) Assignees: Hyundai Motor Company, Seoul (KR); Kia Corporation, Seoul (KR)

(21) Appl. No.: 18/938,655

(22) Filed: Nov. 6, 2024

(30) Foreign Application Priority Data
Jun. 19, 2024 (KR) 10-2024-0079898

(51) Int. Cl. B62D 21/15; B62D 21/11; B62D 25/04; B62D 25/14

(52) U.S. Cl. CPC B62D 21/152; B62D 21/11; B62D 25/04; B62D 25/14

(57) ABSTRACT

A front side vehicle body includes a front side member extending in a longitudinal direction of a vehicle, a shock absorber housing disposed between a front end portion of the front side member and a rear end portion thereof and connected to the front side member, and an A-pillar connected to the rear end portion of the front side member. The front side member, the shock absorber housing, and the A-pillar are integrally molded. The A-pillar includes an energy absorbing portion provided at a front portion thereof, formed to extend in a height direction of a vehicle, and formed to protrude outwards. The A-pillar is welded to the energy absorbing portion.

### CROSS-REFERENCE TO RELATED APPLICATION

The present application claims priority to Korean Patent Application No. 10-2024-0079898, filed on Jun. 19, 2024, the entire contents of which is incorporated herein for all purposes by this reference.

### BACKGROUND OF THE PRESENT DISCLOSURE

### Field of the Present Disclosure

The present disclosure relates to a front side vehicle body forming a front side portion of a vehicle body.

### Description of Related art

A front side vehicle body may be formed by assembling more than 50 different parts. To reduce vehicle weight, research and development have been actively conducted on a method of maximally reducing the number of parts used to form the front side vehicle body.

When the front side vehicle body is light in weight, rigidity of the vehicle may deteriorate. For the present reason, there is demand for a front side vehicle body capable of achieving weight reduction of the front side vehicle body and providing sufficient rigidity to protect a passenger in the event of vehicle collision.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a front side vehicle body configured for achieving weight reduction of the front side vehicle body and providing sufficient rigidity to protect a passenger in the event of vehicle frontal collision.

In accordance with the present disclosure, the above and other objects may be accomplished by the provision of a front side vehicle body including a front side member extending in a longitudinal direction of a vehicle, a shock absorber housing disposed between a front end portion of the front side member and a rear end portion thereof and connected to the front side member, and an A-pillar connected to the rear end portion of the front side member, wherein the A-pillar includes an energy absorbing portion formed at a front portion thereof and formed to be open to an interior of a vehicle in the front side vehicle body obtained by integrally molding the front side member, the shock absorber housing, and the A-pillar.

The front side member, the shock absorber housing, and the A-pillar may be integrally molded, at least one of the front side member, the shock absorber housing, or the A-pillar may include a main rib formed therein, and the energy absorbing portion may include a sub-rib provided therein.

The main rib or the sub-rib may include at least one of a horizontal rib extending in the longitudinal direction of the vehicle, a vertical rib extending in a height direction of the vehicle, or a diagonal rib extending in a direction passing through an intersection point between the vertical rib and the horizontal rib.

The front side vehicle body may further include a fender apron member including a first end portion connected to the front end portion of the front side member and a second end portion connected to a front end portion of the shock absorber housing.

The energy absorbing portion may include an opening width equal to a width of the fender apron member.

The fender apron member may be integrally molded with the front side member, the shock absorber housing, and the A-pillar.

The energy absorbing portion may include a shape extending in a height direction of the vehicle.

The A-pillar may have at least one energy absorbing portion formed at the front portion thereof.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 and FIG. 2 are perspective views of a front side vehicle body according to an exemplary embodiment of the present disclosure;

FIG. 3 is a view showing the external surface of the front side vehicle body according to the exemplary embodiment of the present disclosure, and FIG. 4 is a view showing the lower surface of the front side vehicle body according to the exemplary embodiment of the present disclosure;

FIG. 5, FIG. 6, and FIG. 7 are views each showing a cross section of an A-pillar of various exemplary embodiments depending on the number of energy absorbing portions formed in the A-pillar;

FIG. 8 is a view showing the external surface of the front side vehicle body according to the exemplary embodiment of the present disclosure;

FIG. 9 is a view showing the internal surface of the front side vehicle body according to the exemplary embodiment of the present disclosure; and

FIG. 10 is a view showing a load transmission path in the event of vehicle frontal collision.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure will be described in detail through exemplary embodiments thereof with reference to the accompanying drawings. Wherever possible, the same reference numbers will be used throughout the drawings to refer to the same or like portions, and redundant descriptions thereof will be omitted.

In describing the exemplary embodiments included herein, when it is determined that a detailed description of publicly known techniques to which the present disclosure pertains may obscure the gist of the present disclosure, the detailed description will be omitted. Furthermore, it should be understood that the accompanying drawings are merely illustrated to easily describe the exemplary embodiments included in the present specification, and therefore, the technical idea included in the present specification is not limited by the accompanying drawings. Furthermore, it should be noted that the accompanying drawings include all modifications, equivalents, and substitutes that fall within the spirit and technical scope of the present disclosure.

Meanwhile, in an exemplary embodiment of the present disclosure, terms such as “first” and/or “second” may be used to describe various components, but the components are not limited by the terms. The terms are used only for distinguishing one component from other components.

In the present specification, an expression in a singular form also includes the plural sense, unless clearly specified otherwise in context.

It should be understood that expressions such as “comprise” and “have” in the present specification are intended to designate the presence of indicated features, numbers, steps, operations, components, parts, or combinations thereof, but do not exclude the presence or addition of one or more features, numbers, steps, operations, components, parts, or combinations thereof.

Hereinafter, the suffixes “module”, “unit”, and “part” for components used in the following description are merely provided for facilitation of preparing the present specification. Therefore, the suffixes themselves do not have significant meanings or roles.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween.

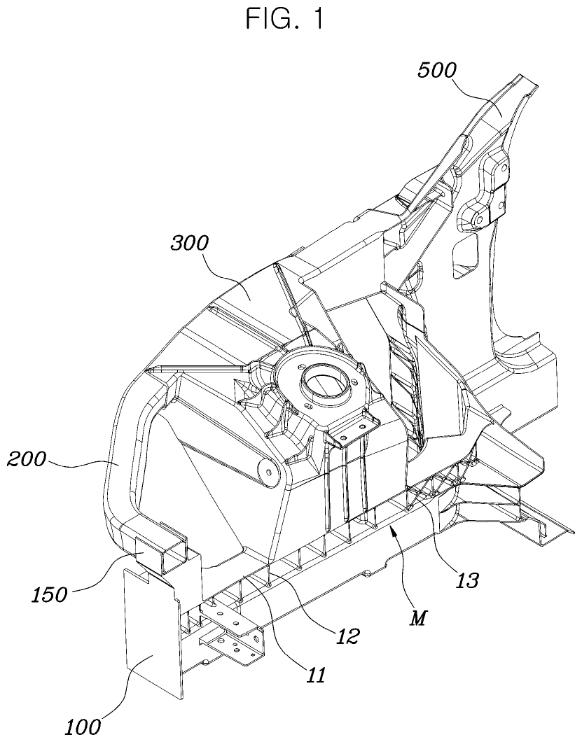

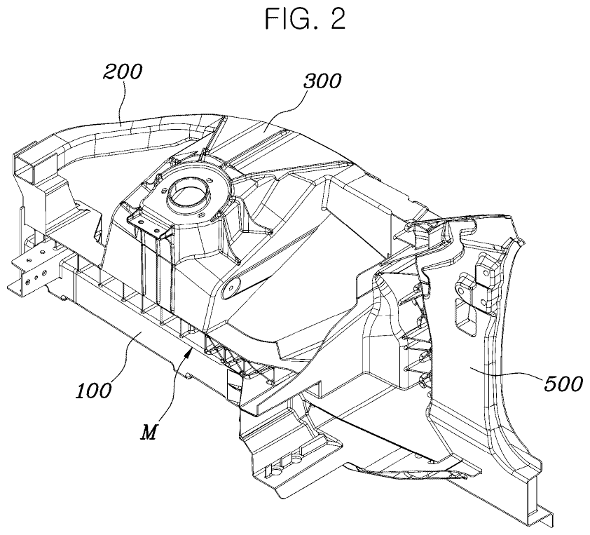

FIG. 1 and FIG. 2 are perspective views of a front side vehicle body according to an exemplary embodiment of the present disclosure.

Referring to FIG. 1 and FIG. 2, the front side vehicle body according to the exemplary embodiment of the present disclosure includes a front side member 100, a shock absorber housing 300, and an A-pillar 500. The front side member 100, the shock absorber housing 300, and the A-pillar 500 are integrally molded and manufactured.

The front side vehicle body is a side structure of a vehicle that extends from a front portion of the vehicle to a rear portion thereof. In the event of vehicle frontal collision, the front side vehicle body absorbs a load (energy) and uniformly distributes the absorbed load throughout the entire vehicle body to protect a passenger from collision.

The front side vehicle body may be manufactured by welding various parts as well as the front side member 100, the shock absorber housing 300, and the A-pillar 500. During the present manufacturing process, approximately 30 to 50 or more parts may be welded to each other and combined with each other.

A method of manufacturing the front side vehicle body through welding is required to form many flanges configured to connect parts to each other, which causes an increase in weight of the front side vehicle body. Furthermore, since many parts need to be manufactured separately, there is a disadvantage of increasing time and labor for manufacture of parts.

In an exemplary embodiment of the present disclosure, the above-described problem may be solved by integrally molding a part or all of the parts used in the front side vehicle body, making it possible not only to maximally reduce welding between the parts, but also to reduce weight of the front side vehicle body.

According to an exemplary embodiment of the present disclosure, the front side member 100, the shock absorber housing 300, and the A-pillar 500, which occupy a large volume in the front side vehicle body, are integrally molded.

According to the above-described method, since the front side member 100, the shock absorber housing 300, and the A-pillar 500, which occupy most of the volume of the front side vehicle body, are integrally molded, the number of welded surfaces may be maximally reduced.

When the number of welded surfaces increases, the welded surfaces are likely to be broken by load. When the weld surfaces are broken, it becomes difficult to transmit the load. Furthermore, an excessive load may be concentrated on a specific portion, and other weld surfaces may be broken. As a result, it may be difficult to uniformly distribute the load.

Meanwhile, the above-described method includes an advantage of maximally reducing the number of welded surfaces, allowing a load to be reliably and uniformly transmitted and distributed through a front side vehicle body.

The front side vehicle body according to an exemplary embodiment of the present disclosure includes a left front side vehicle body and a right front side vehicle body provided to be symmetrical with each other and configured to be connected to each other through a crossbar and the like. A space defined between the left front side vehicle body and the right front side vehicle body may form an engine compartment or a space in which PE portions of an electric vehicle are provided.

Meanwhile, to sufficiently absorb an impact load and transmit the same to the A-pillar 500 in the event of vehicle frontal collision, the front side vehicle body includes an energy absorbing portion 625 disposed at a front portion of the A-pillar 500, formed to extend in the height direction of a vehicle, and formed to be open to the internal side of the vehicle.

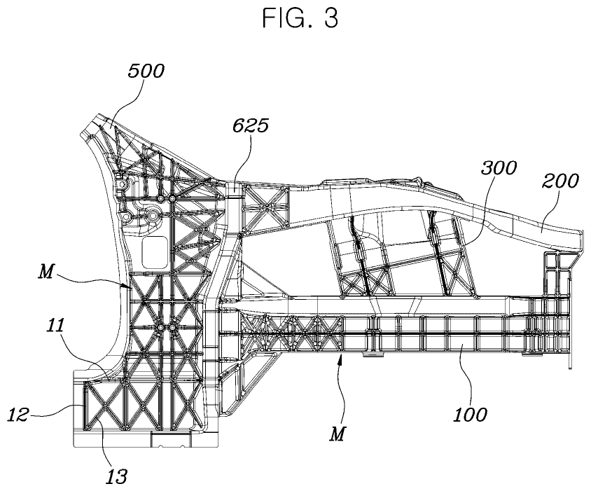

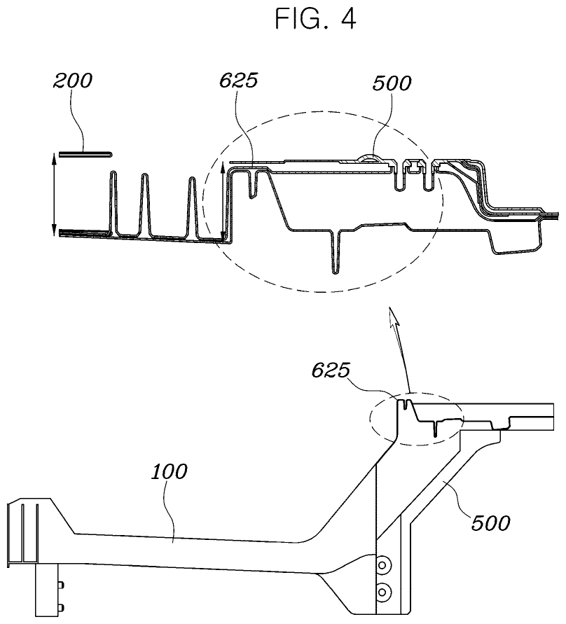

FIG. 3 is a view showing the external surface of the front side vehicle body according to the exemplary embodiment of the present disclosure, and FIG. 4 is a view showing the lower surface of the front side vehicle body according to the exemplary embodiment of the present disclosure.

Referring to FIG. 3, the A-pillar 500 includes the energy absorbing portion 625 disposed at the front portion thereof and formed to protrude outwards.

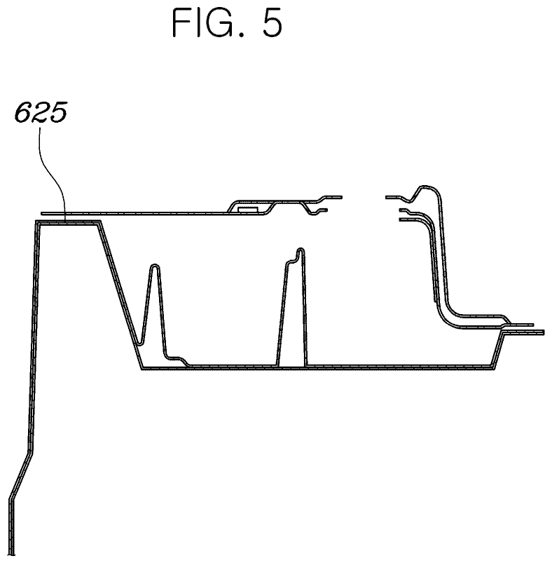

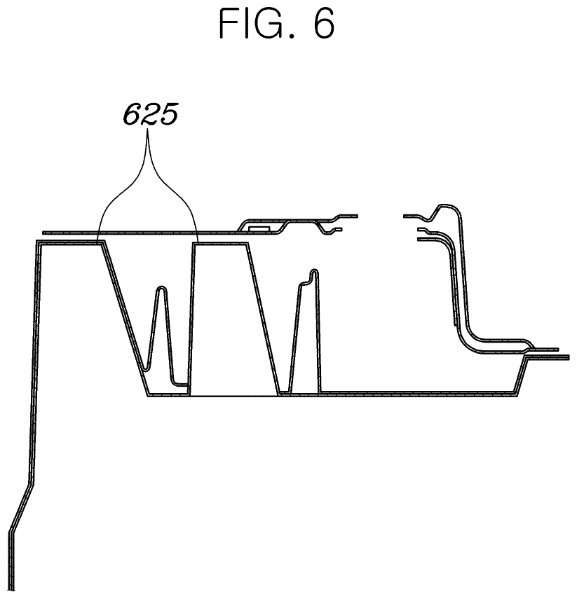

Here, the single energy absorbing portion 625 may be formed in the A-pillar 500, but a plurality of energy absorbing portions 625 may be formed therein to form a plurality of energy absorbing portions configured to absorb energy transmitted to the A-pillar. FIGS. 5, to 7 are views each showing a cross section of the A-pillar of various exemplary embodiments depending on the number of energy absorbing portions formed in the A-pillar.

The A-pillar 500 of the front side vehicle body according to an exemplary embodiment of the present disclosure are formed to be integrated with other components, and the number of energy absorbing portions 625 may be increased or reduced as necessary.

Meanwhile, referring to FIG. 1, FIG. 2, and FIG. 3, a main rib M may be provided in at least one of the front side member 100, the shock absorber housing 300, and the A-pillar 500 that are integrally molded, and a sub-rib S may be provided at the inside of the energy absorbing portion.

A size of the main rib M is equal to or greater than a size of the sub-rib S.

Both the main rib M and the sub-rib S may include horizontal ribs 11 each extending in the longitudinal direction of the vehicle and vertical ribs 12 each extending in the height direction of the vehicle.

First, the main rib M will be described below. The main rib M is formed in at least one of the front side member 100, the shock absorber housing 300, and the A-pillar 500 that are integrally molded. Here, the horizontal ribs 11 and the vertical ribs 12 forming the main rib M may be formed to intersect each other to form a space in the main rib M.

Some portions forming the base of the front side vehicle body are integrally molded and manufactured. Since the portions are cast integrally, the front side vehicle body is manufactured with an open cross-section. During casting, the front side vehicle body may be manufactured by injecting the parts into an aluminum or aluminum-containing alloy mold.

In general, an open cross-section has lower rigidity than that of a closed cross-section. For the present reason, to secure rigidity of the front side vehicle body, the horizontal ribs 11 and the vertical ribs 12 may be formed in at least one of the front side member 100, the shock absorber housing 300, and the A-pillar 500.

The horizontal ribs 11 and the vertical ribs 12 intersect each other to form a space in the front side member 100, the shock absorber housing 300, and the A-pillar 500. The horizontal ribs 11 and the vertical ribs 12 may effectively distribute stress applied to a vehicle body and may partially absorb the stress, increasing rigidity of the open cross-section. Additionally, the space formed by the horizontal ribs 11 and the vertical ribs 12 may provide a space allowing the vehicle body to be deformed in the event of vehicle collision and may absorb a load generated by vehicle collision.

Here, the space formed by intersecting the horizontal ribs 11 and the vertical ribs 12 may be formed to face the interior of the vehicle or the outside thereof. That is, the horizontal ribs 11 and the vertical ribs 12 may be formed on the left side or the right side of the vehicle body in the width direction of the vehicle, forming a space facing the interior of the vehicle or the outside thereof.

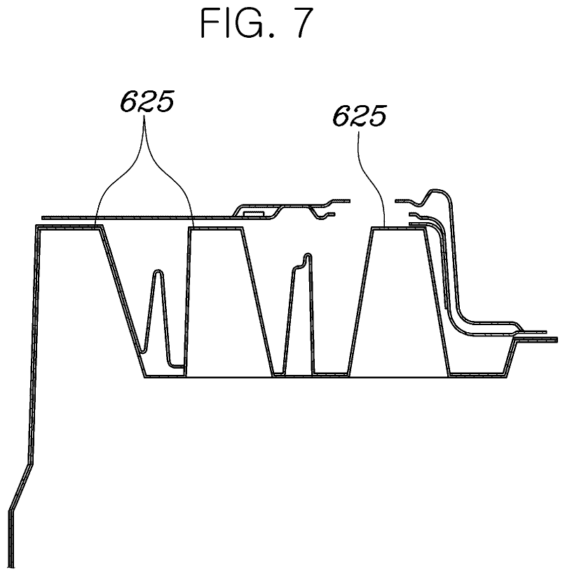

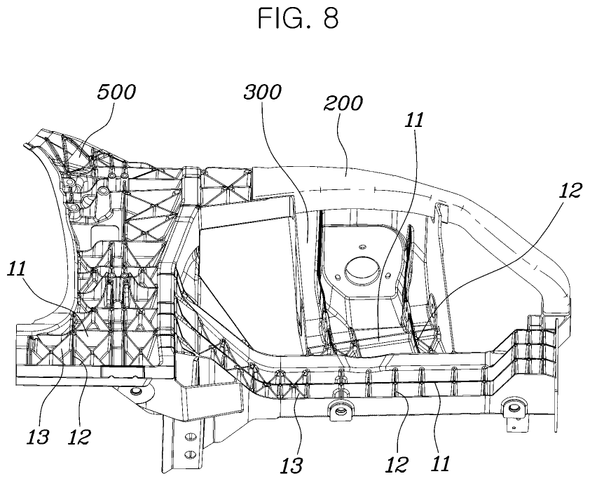

FIG. 8 is a view showing the external surface of the front side vehicle body according to the exemplary embodiment of the present disclosure. Referring to FIG. 8, the horizontal ribs 11 and the vertical ribs 12 form a plurality of spaces in the front side member 100, the shock absorber housing 300, and the A-pillar 500, and the plural spaces are directed to the outside of the vehicle.

Additionally, referring to FIG. 1, the horizontal ribs 11 and the vertical ribs 12 are formed at a plurality of points in the front side member 100 to face the interior of the vehicle.

Referring to FIG. 8, a space is formed by crossing a plurality of horizontal ribs 11 and the vertical ribs 12 at the front end portion of the front side member 100 of the integrally molded front side vehicle body.

In the event of vehicle frontal collision, a first portion to which an impact load is applied is the front end portion of the front side member 100. Therefore, in the event of vehicle frontal collision, the front end portion of the front side member 100 is required to be sufficiently deformed to appropriately transmit and distribute the impact load to other adjacent portions of the vehicle. To the present end, the horizontal ribs 11 and the vertical ribs 12 are formed to intersect each other from the front end portion of the front side member 100. As a result, a space is formed in the front side vehicle body toward the interior of the vehicle or the outside thereof.

The above-mentioned space allows the front side member 100 to be sufficiently deformed by load applied thereto in the event of vehicle front collision. In other words, the front side member 100 needs to include a sufficient deformation space provided therein and configured to cause deformation of the front side member 100 by load. The front side member 100 is sufficiently deformed through the space formed by the horizontal ribs 11 and the vertical ribs 12, allowing the load to be effectively transmitted to the A-pillar 500.

Furthermore, the main rib M may further include diagonal ribs 13 each passing through a central point of the horizontal rib 11 or an intersection point between the horizontal rib 11 and the vertical rib 12.

When the diagonal ribs 13 are additionally provides in the main rib M, a space formed by the horizontal ribs 11 and the vertical ribs 12 is divided, increasing a cross-sectional area of a vehicle body. As a result, the front side vehicle body may secure greater rigidity.

Accordingly, additional formation of the diagonal ribs 13 enables the front side vehicle body to gain additional rigidity, reducing a degree of deformation due to load. Sufficient deformation of the front side vehicle body is important in transmitting and distributing a load, but continued deformation of the vehicle body may cause physical damage to a passenger. In the case of a vehicle body located close to a passenger, it is important to reduce a degree of deformation to protect a passenger from vehicle frontal collision.

That is, the front end portion of the front side member 100, which is relatively far away from a passenger, includes the horizontal ribs 11 and the vertical ribs 12 formed therein to enable sufficient deformation thereof. Through the present structural configuration, a load is effectively transmitted and distributed to the A-pillar 500 in the event of vehicle collision. In the instant case, the front end portion of the front side member 100 may be formed from the front end portion of the front side member 100 to a portion at which the shock absorber housing is disposed.

Meanwhile, in the case of a portion located behind the portion at which the shock absorber housing 300 of the front side member 100 is disposed, the front side vehicle body is located relatively close to a passenger. Therefore, from the above-mentioned portion located behind the shock absorber housing 300, it is required to reduce a degree of deformation of the vehicle body to protect a passenger from excessive deformation of the vehicle body.

Accordingly, the additional diagonal ribs 13 are formed at the rear end portion of the front side member 100, which is relatively close to a passenger, to secure additional rigidity and reduce a degree of deformation of the vehicle body compared to that of the front end portion of the front side member 100, making it possible to prevent a passenger from being injured due to deformation of the vehicle body.

The diagonal ribs 13 may be additionally provided not only in the front side member 100 but also in the A-pillar 500, preventing a passenger from being injured due to deformation of the vehicle body.

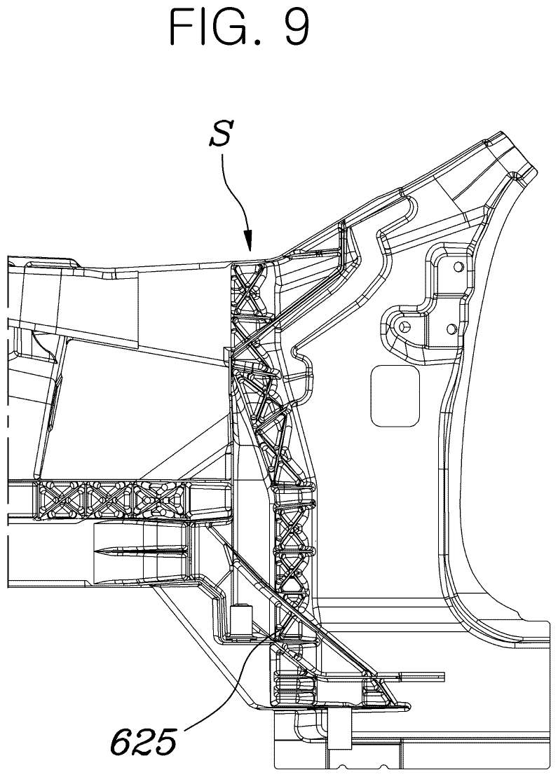

FIG. 9 is a view showing the internal surface of the front side vehicle body according to the exemplary embodiment of the present disclosure. Referring to FIG. 9, the sub-rib S is provided in the energy absorbing portion 625.

The sub-rib S may further include the horizontal ribs 11 each extending in the longitudinal direction of the vehicle, the vertical ribs 12 each extending in the height direction of the vehicle, and the diagonal ribs 13 each passing through a central point of the horizontal rib 11 or an intersection point of the horizontal rib 11 and the vertical rib 12. Here, the horizontal ribs 11 and the vertical ribs 12 may be omitted in the sub-rib S, and only the diagonal ribs 13 may be formed therein.

The sub-rib S formed in the energy absorbing portion may have various designs. For example, an area occupied by the sub-rib S may be designed to be smaller than an area occupied by the main rib M.

A height formed by the sub-rib S may be designed to be the same as a height formed by the main rib M, and a width formed by the sub-rib S may be designed to be smaller than a width formed by the main rib M.

Alternatively, the height formed by the sub-rib S may be half of the height formed by the main rib M, and the width formed by the sub-rib S may be the same as the width formed by the main rib M.

In the present manner, the cross-sectional area occupied by the sub-rib S is formed to be smaller than the cross-sectional area occupied by the main rib M, causing deformation of the sub-rib S formed in the energy absorbing portion 625. Accordingly, it is possible to absorb an impact load caused by vehicle frontal collision and to transmits the impact load to the A-pillar.

The sub-rib S provided in the energy absorbing portion 625 may be provided in an “X” shape by omitting the horizontal ribs 11 or the vertical ribs 12 for easy deformation thereof. Furthermore, the sub-rib S may be provided in various shapes.

Meanwhile, the front side vehicle body according to an exemplary embodiment of the present disclosure may further include a fender apron member 200 including one end portion connected to the front end portion of the front side member 100 and the other end portion connected to the front end portion of the shock absorber housing 300. Referring to FIGS. 1 to 10, the fender apron member 200 may be integrally molded with the front side member 100, the shock absorber housing 300, and the A-pillar 500, or may be provided as a separate configuration.

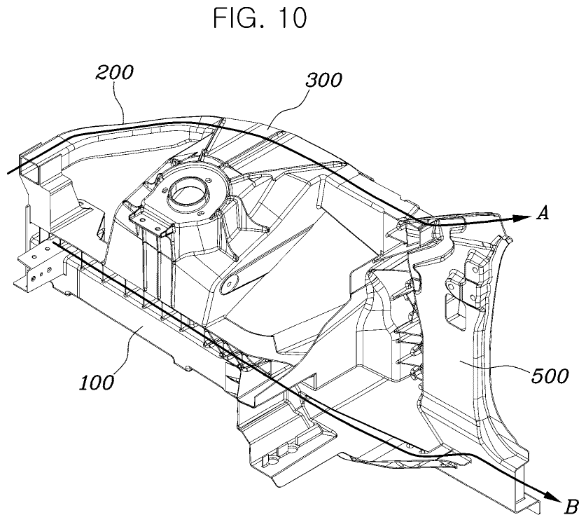

In the event of vehicle frontal collision, a load transmission path may be formed by use of the fender apron member 200, as shown in FIG. 10. That is, an impact load applied to the front side member 100 may move to the A-pillar 500 through the fender apron member 200 and the shock absorber housing 300 (load transmission path A).

Additionally, the impact load applied to the front side member 100 may pass through the front side member 100 and move directly to the A-pillar 500 (load transmission path B).

Since the front side member 100, the shock absorber housing 300, the A-pillar 500, and the fender apron member 200 are molded to be integrated with each other, there is no weld line or welded surface between components. As a result, since a load is constantly transmitted through the load transmission path without interruption in the event of vehicle frontal collision, the load may be smoothly moved to the A-pillar 500, ensuring that the load is uniformly distributed throughout the vehicle body.

Meanwhile, referring to FIG. 4, the width of the energy absorbing portion 625 formed in the A-pillar 500 may be the same as the width of the fender apron member 200. When the width of the fender apron member 200 and the width of the energy absorbing portion 625 are formed to be the same, it becomes easier to perform load transmission. Accordingly, a load is easily moved from the fender apron member 200 to the A-pillar 500, making it possible to uniformly distribute an impact load throughout the vehicle in the event of vehicle collision.

As is apparent from the above description, the present disclosure provides a lightweight front side vehicle body obtained by integrally molding a front side member, a shock absorber housing, and an A-pillar.

Furthermore, the present disclosure provides an energy absorbing portion including a cross section to which the A-pillar is welded, making it possible not only to sufficiently absorb an impact load in the event of vehicle frontal collision, but also to reliably transmit the impact load to the A-pillar.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A front side vehicle body comprising:
a front side member extending in a longitudinal direction of a vehicle;
a shock absorber housing disposed between a front end portion of the front side member and a rear end portion of the front side member and connected to the front side member; and
an A-pillar connected to the rear end portion of the front side member,
wherein the A-pillar includes an energy absorbing portion formed at a front portion of the A-pillar and formed to be open to an interior of the vehicle in the front side vehicle body,
wherein the front side member, the shock absorber housing, and the A-pillar are integrally molded.

2. The front side vehicle body of claim 1,
wherein at least one of the front side member, the shock absorber housing, or the A-pillar includes a main rib formed therein, and
wherein the energy absorbing portion includes a sub-rib formed in the energy absorbing portion.

3. The front side vehicle body of claim 1, wherein a size of the main rib is equal to or greater than a size of the sub-rib.

4. The front side vehicle body of claim 1, wherein a cross-sectional area occupied by the sub-rib is smaller than a cross-sectional area occupied by the main rib.

5. The front side vehicle body of claim 2, wherein the main rib includes at least one of a horizontal rib extending in the longitudinal direction of the vehicle, a vertical rib extending in a height direction of the vehicle, or a diagonal rib extending in a direction passing through an intersection point between the vertical rib and the horizontal rib.

6. The front side vehicle body of claim 5, wherein the front end portion of the front side member includes the horizontal rib and the vertical rib and the rear end portion of the front side member includes the horizontal rib, the vertical rib and the diagonal rib.

7. The front side vehicle body of claim 2, wherein the sub-rib includes at least one of a horizontal rib extending in the longitudinal direction of the vehicle, a vertical rib extending in a height direction of the vehicle, or a diagonal rib extending in a direction passing through an intersection point between the vertical rib and the horizontal rib.

8. The front side vehicle body of claim 1, further including a fender apron member including a first end portion connected to the front end portion of the front side member and a second end portion connected to a front end portion of the shock absorber housing.

9. The front side vehicle body of claim 8, wherein the energy absorbing portion has a width equal to a width of the fender apron member.

10. The front side vehicle body of claim 8, wherein the fender apron member is integrally molded with the front side member, the shock absorber housing, and the A-pillar.

11. The front side vehicle body of claim 1, wherein the energy absorbing portion extends in a predetermined length in a height direction of the vehicle.

12. The front side vehicle body of claim 1, wherein the energy absorbing portion is in plural and the A-pillar includes the plurality of energy absorbing portions formed at the front portion of the A-pillar.
